(19) United States
(12) Patent Application Publication
(10) Pub. No.: US 2010/0148958 A1
(43) Pub. Date: Jun. 17, 2010

(54) EXPIRATION WARNING DEVICE OF REFRIGERATOR

(76) Inventor: Ching-Chung CHEN, Taipei County (TW)

Correspondence Address: Muncy, Geissler, Olds & Lowe, PLLC, 4000 Legato Road, Suite 310, FAIRFAX, VA, 22033, US

(21) Appl. No.: 12/335,004

(22) Filed: Dec. 15, 2008

(51) Int. Cl. G08B 21/00

(52) U.S. Cl. 340/540

(57) ABSTRACT

An expiration warning device installed on a refrigerator includes a processor unit, a power source unit electrically connected to the processor unit, an operating unit electrically connected to the processor unit for setting a countdown of number of days, at least one display unit electrically connected to the processor unit for displaying the countdown of number of days, at least one switch unit electrically connected to processor unit for controlling the power source unit and the display unit, and at least one warning unit electrically connected to the processor unit and corresponding to the display unit for alerting the countdown of number of days. The processor unit, power source unit, operating unit, display unit, switch unit and warning unit are coupled to a casing and installed on the refrigerator for setting a countdown of expiration of related foods to remind users about the expiration in advance.

### FIELD OF THE INVENTION

The present invention relates to an expiration warning device of a refrigerator, and more particularly to an expiration warning device installed on a refrigerator for setting a countdown of the expiration of related foods to achieve the effect of reminding users about the expiration of food in advance.

### BACKGROUND OF THE INVENTION

To maintain freshness, food including raw and cooked food, diary and egg products, can food, fruit or snack and medical healthcare products including medicines and cosmetics are generally stored in a refrigerator or a freezer for preserving the food and medical healthcare products.

Although the freshness of the food and medical healthcare products can last longer in the refrigerator, each food item or medical healthcare product still comes with an expiration date. It is inappropriate to eat or use any expired food or medical healthcare product, and will cause adverse effects to our health. In general, a refrigerator only provides a cold storage of the food, but not the information of the storage and the expiration date of each food item or medical healthcare product. Since a refrigerator usually stores various foods at a low temperature, users are unable to remember the expiration of various foods or medical healthcare products one by one, and it is common to see expired food or medical healthcare product in a refrigerator, not only wasting electric power and money, but also jeopardizing our health if the expired food or medical healthcare product is eaten or used by mistake.

### SUMMARY OF THE INVENTION

Therefore, it is a primary objective of the present invention to provide an expiration warning device installed on a refrigerator for setting a countdown of expiration for related foods to achieve the effect of reminding users about the expiration in advance.

To achieve the foregoing objective, the present invention provides an expiration warning device of a refrigerator, wherein the expiration warning device is installed on the refrigerator, and the expiration warning device comprises a processor unit, a power source unit electrically coupled to the processor unit, an operating unit electrically coupled to the processor unit for setting a countdown of number of days, at least one display unit electrically coupled to the processor unit for displaying the countdown of number of days, at least one switch unit electrically coupled to the processor unit for controlling the power source unit and the display unit; and at least one warning unit electrically coupled to the processor unit and corresponding to the display unit, so as to alert users about the countdown of number of days.

### BRIEF DESCRIPTION OF THE DRAWINGS

FIG. 1 is a perspective view of a first preferred embodiment of the present invention;

FIG. 2 is a schematic block diagram of a first preferred embodiment of the present invention;

FIG. 3A is a schematic circuit diagram (I) of a first preferred embodiment of the present invention;

FIG. 3B is a schematic circuit diagram (II) of a first preferred embodiment of the present invention;

FIG. 4 is a perspective view of a second preferred embodiment of the present invention;

FIG. 5 is a schematic view of an application of a first preferred embodiment of the present invention; and

FIG. 6 is a schematic view of another application of a first preferred embodiment of the present invention.

### DESCRIPTION OF THE PREFERRED EMBODIMENT

Other features and advantages of the present invention will become apparent in the following detailed description of the preferred embodiments with reference to the accompanying drawings.

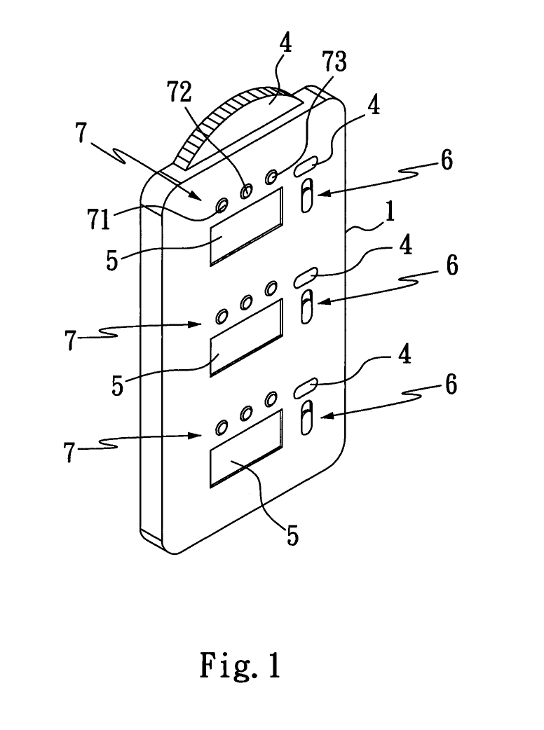

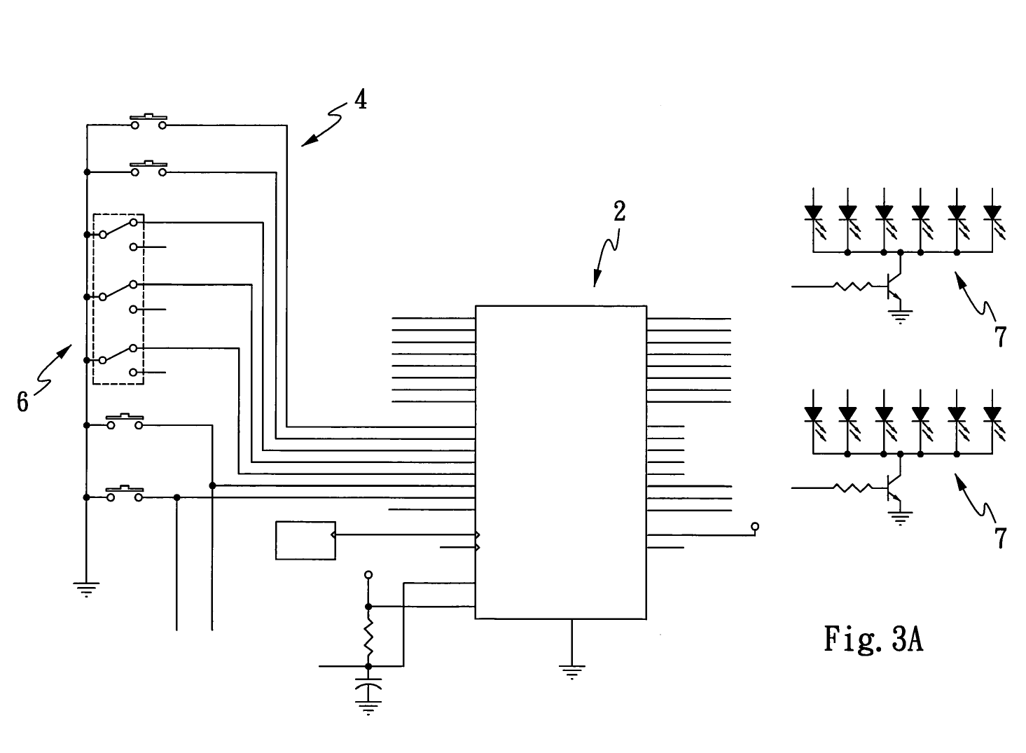

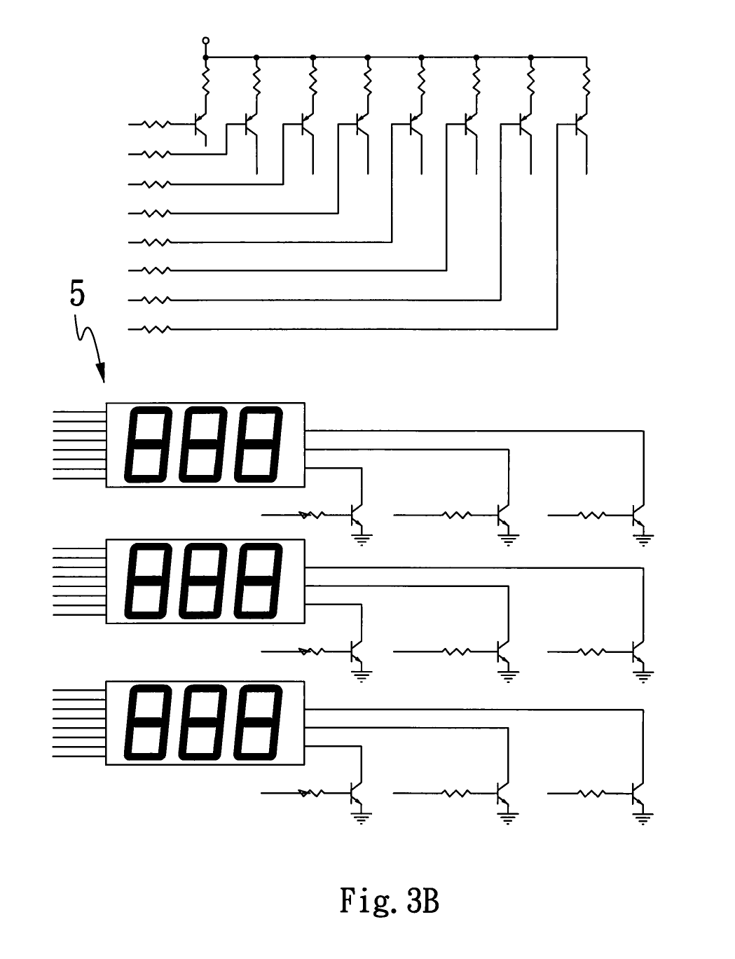

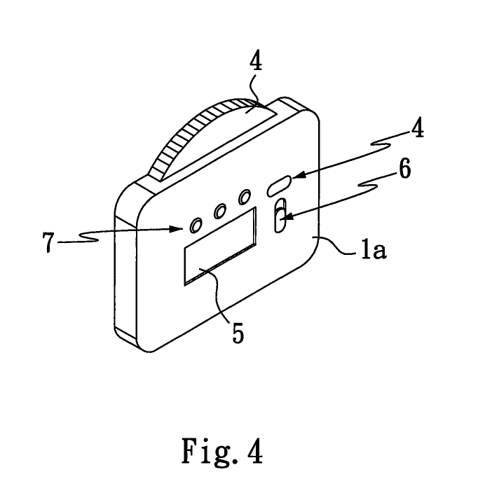

With reference to FIGS. 1 to 4 for a perspective view of a first preferred embodiment of the present invention, a schematic block diagram of a first preferred embodiment of the present invention, a schematic circuit diagram (I) and (II) of a first preferred embodiment of the present invention and a perspective view of a second preferred embodiment of the present invention respectively, an expiration warning device is installed on a refrigerator, and the expiration warning device comprises a casing 1 coupled to the refrigerator, a processor unit 2 coupled to the casing 1, a power source unit 3, an operating unit 4, at least one display unit 5, at least one switch unit 6 and at least one warning unit 7, wherein the operating unit 4, the display unit 5, the switch unit 6 and the warning unit 7 are exposed from an external surface of the casing 1. Besides the installation of a plurality of display units 5, switch units 6 and warning units 7 on the casing 1 (as shown in FIG. 1), one display unit 5, one switch unit 6 and one warning unit 7 can be installed on a casing 1 a (as shown in FIG. 4) instead. The present invention is illustrated by the preferred embodiment as shown in FIG. 1.

The processor unit 2 is used as a central control unit for controlling the execution and operation of each unit and is made of a single chip or an integrated circuit.

The power source unit 3 is electrically coupled to the processor unit 2, and the power source unit 3 can be a general battery of a built-in rechargeable battery, or a power source electrically coupled to the refrigerator.

The operating unit 4 is electrically coupled to the processor unit 2 for setting the required countdown of number of days, and the operating unit 4 can be a knob, a press button or any other press button.

Each display unit 5 is electrically coupled to a processor unit for displaying the countdown of number of days, and each display unit 5 can be a display screen.

Each switch unit 6 is electrically coupled to the processor unit 2 for controlling the power source unit 3 and the display unit 5, and each switch unit 6 can be a DIP switch, a press switch or any other switch.

Each warning unit 7 is electrically coupled to the processor unit 2 and corresponding to each display unit 5 for providing a related warning of the countdown of number of days, wherein each warning unit 7 comprises three light emitting diodes 71, 72, 73, and the warning unit 7 can be a light emitting diode and/or a speaker (not shown in the figure) as needed. The aforementioned structure integrated with a refrigerator constitutes a novel expiration warning device of a refrigerator.

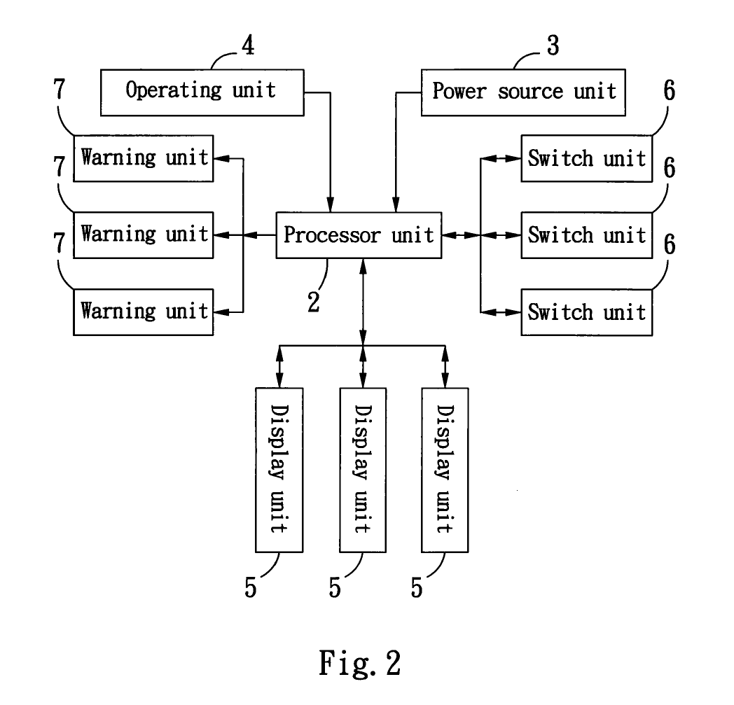

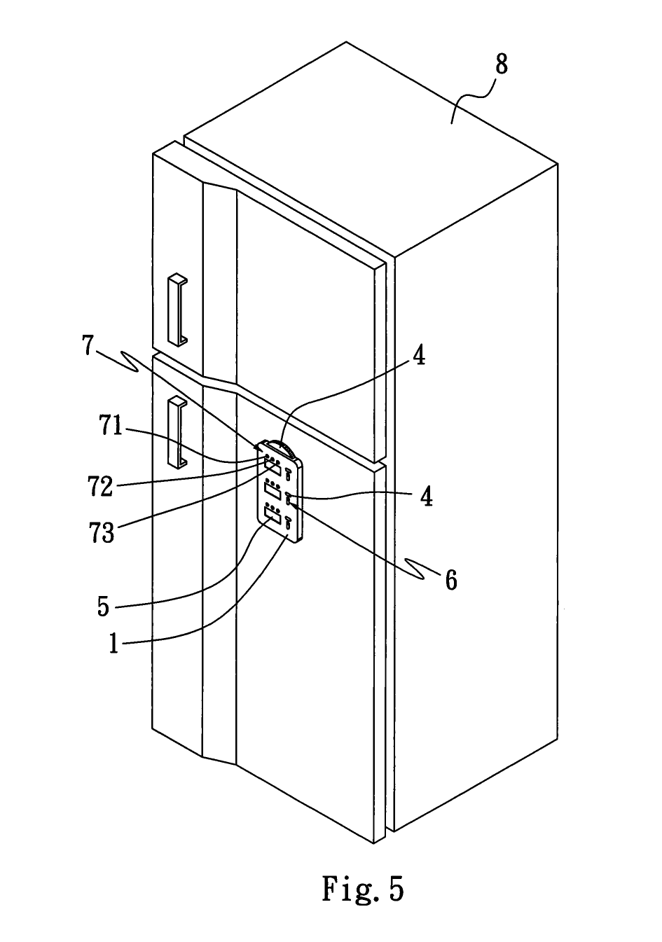

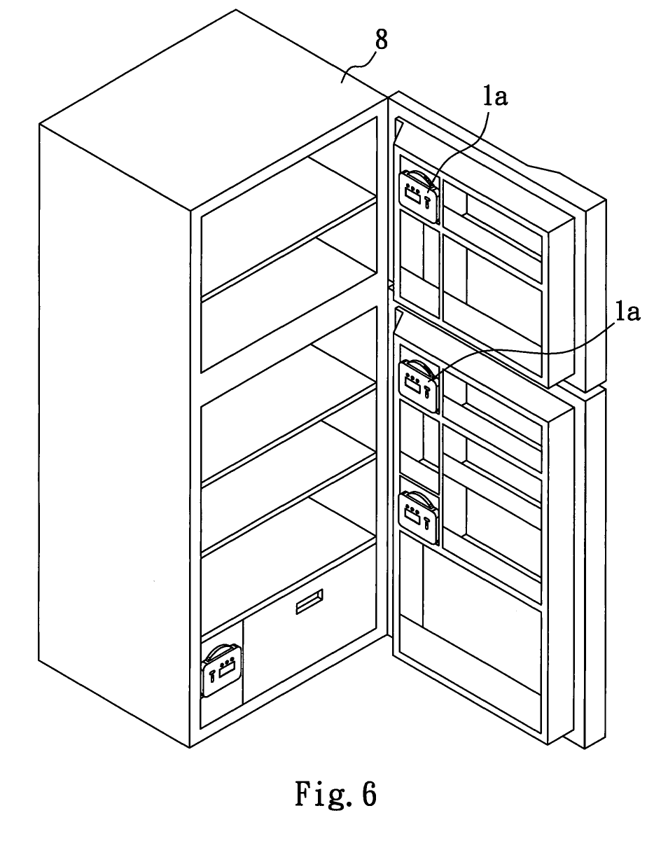

With reference to FIGS. 5 and 6 for schematic views of applications of a first preferred embodiment of the present invention, when the present invention is applied (see FIG. 2 as well), it can be used in a refrigerator 8 (such as a refrigerator, a storage cabin, a freshness preserving box or any other storage container, and a refrigerator is used in this embodiment). During use, the operating unit 4, the display unit 5, the switch unit 6 and the warning unit 7 provide a countdown of number of days for each food or different foods to control the expiration date.

During a setup, a user turns on the switch unit 6 to supply electric power from the power source unit 3, and sets the number of remaining days before the expiration date through the operating unit 4, the display unit 5 and the processor unit 2. After the setup is completed, the casing 1 is installed outside the refrigerator 8 or the single casing 1a is installed inside the refrigerator 8 for labeling a corresponding display unit 5 on the package of the controlled food to start a countdown of the expiration, and the display unit 5 is provided for displaying the number of remaining days before the expiration. In the meantime, the warning unit 7 alerts users about the number of days on the display unit 5 by a light signal, a sound or a text. In a warning in accordance with the present embodiment, three light emitting diodes 71, 72, 73 of each warning unit 7 are used for the providing the reminder instructions. For example, a continuously blinked green light source is emitted from the light emitting diode 71 to remind users about the safe period of eating/using the food; a continuously lit or blinked yellow light source is emitted from the light emitting diode 72 to warn the users about the about-to-expire situation of the food and remind the users to notice the expiration date and eat/use the food as soon as possible; or a continuously lit red light source is emitted from the light emitting diode 73 to warn the users about the expiration of the food, and remind the users not to eat/use the food anymore. Therefore, the present invention can set a countdown for the expiration to achieve the effect of reminding the users about the expiration in advance.

In summation of the description above, the expiration warning device of a refrigerator in accordance with the present invention can overcome the shortcomings of the prior art effectively. In addition to the processor unit, the power source unit, the operating unit, the display unit, the switch unit and the warning unit coupled to a casing and disposed on the refrigerator, the processor unit, the power source unit, the operating unit, the display unit, the switch unit and the warning unit can be made in a module, installed on the refrigerator directly, and integrated with the refrigerator. The countdown of expiration for related food is set to achieve the effect of reminding a user about the expiration in advance. The present invention complies with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An expiration warning device of a refrigerator, and the refrigerator comprising:
a processor unit;
a power source unit, electrically coupled to the processor unit;
an operating unit, electrically coupled to the processor unit, for setting a countdown of number of days;
at least one display unit, electrically coupled to the processor unit, for displaying the countdown of number of days;
at least one switch unit, electrically coupled to the processor unit, for controlling the power source unit and the display unit; and
at least one warning unit, electrically coupled to the processor unit and corresponding to the display unit, and provided for alerting the countdown of number of days.

2. The expiration warning device of a refrigerator as recited in claim 1, wherein the processor unit, the power source unit, the operating unit, the display unit, the switch unit and the warning unit are coupled to a casing, and the operating unit, the display unit, the switch unit and the warning unit are exposed from an external surface of the casing.

3. The expiration warning device of a refrigerator as recited in claim 1, wherein the operating unit is a knob.

4. The expiration warning device of a refrigerator as recited in claim 1, wherein the display unit is a display screen.

5. The expiration warning device of a refrigerator as recited in claim 1, wherein the warning unit is a light emitting diode.

6. The expiration warning device of a refrigerator as recited in claim 1, wherein the warning unit comprises three light emitting diodes.

7. The expiration warning device of a refrigerator as recited in claim 1, wherein the warning unit is a speaker.
